(19) United States
(12) Patent Application Publication
(10) Pub. No.: US 2026/0072586 A1
(43) Pub. Date: Mar. 12, 2026

(54) VIEWFINDER IN HEAD-WEARABLE DEVICE DISPLAY

(71) Applicant: Snap Inc., Santa Monica, CA (US)

(72) Inventors: Mitchell Kuppersmith, Los Angeles, CA (US); Karen Stolzenberg, Venice, CA (US)

(21) Appl. No.: 18/829,019

(22) Filed: Sep. 9, 2024

(51) Int. Cl. G06F 3/0488; G06F 3/04815; G06F 3/0484; G06F 3/16

(52) U.S. Cl. CPC G06F 3/0488; G06F 3/04815; G06F 3/0484; G06F 3/167

(57) ABSTRACT

In an example, two different mechanisms for specifying a real-world object visible in a view are provided. Each of these different mechanisms has their own benefits, and indeed in another example a hybrid of the two mechanisms may be used, where a user can seamlessly switch between mechanisms based on their own desires or scenarios.

### TECHNICAL FIELD

The present disclosure relates generally to user interfaces and, more particularly, to user interfaces used for extended reality. More particularly, the present disclosure relates to how to specify a real-world object in a view, on user devices implementing extended reality.

### BACKGROUND

A head-wearable apparatus can be implemented with a transparent or semi-transparent display through which a user of the head-wearable apparatus can view the surrounding environment. Such head-wearable apparatuses enable a user to see through the transparent or semi-transparent display to view the surrounding environment, and to also see objects (e.g., objects such as a rendering of a 2D or 3D graphic model, images, video, text, and so forth) that are generated for display to appear as a part of, and/or overlaid upon, the surrounding environment. This is typically referred to as “augmented reality” or “AR.” A head-wearable apparatus can additionally completely occlude a user's visual field and display a virtual environment through which a user can move or be moved. This is typically referred to as “virtual reality” or “VR.” In a hybrid form, a view of the surrounding environment is captured using cameras, and then that view is displayed along with augmentation to the user on displays the occlude the user's eyes. As used herein, the term eXtended Reality (XR) refers to augmented reality, virtual reality and any of hybrids of these technologies unless the context indicates otherwise.

A user of the head-wearable apparatus can access and use a computer software application to perform various tasks or engage in an activity. To use the computer software application, the user interacts with a user interface provided by the head-wearable apparatus.

### BRIEF DESCRIPTION OF THE SEVERAL VIEWS OF THE DRAWINGS

In the drawings, which are not necessarily drawn to scale, like numerals can describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1A is a perspective view of a head-wearable apparatus 100 according to some examples.

FIG. 1B illustrates the head-wearable apparatus from the perspective of a user while wearing the head-wearable apparatus.

FIG. 2 illustrates a system including a head-wearable apparatus with a selector input device, according to some examples.

FIG. 3 is a block diagram showing an example digital interaction system for facilitating interactions and engagements (e.g., exchanging text messages, conducting text audio and video calls, or playing games) over a network.

FIG. 4 is a diagrammatic representation of the machine within which instructions (e.g., software, a program, an application, an applet, an app, or other executable code) for causing the machine to perform any one or more of the methodologies discussed herein can be executed.

FIG. 5 illustrates a collaboration diagram of components of an XR system, such as head-wearable apparatus of FIG. 1A, using hand-tracking for user input, according to some examples.

FIG. 6 is a diagram illustrating an XR view, in accordance with an example.

FIGS. 7A and 7B are diagrams illustrating an XR view in a head-only viewfinder mode, in accordance with an example.

FIGS. 8A and 8B are diagrams illustrating an XR view in a hand-only viewfinder mode, in accordance with an example.

FIG. 9A illustrates a machine-learning pipeline, according to some examples.

FIG. 9B illustrates training and use of a machine-learning program, according to some examples.

FIG. 10 is a block diagram showing a software architecture, according to some examples.

### DETAILED DESCRIPTION

When implementing a head-wearable apparatus that is capable of providing an XR experience to a user, it is desirable to provide an interface that allows a user to capture an image of a specific real-world object displayed in the view. This is especially true when the interface also allows querying to take place, such as where an artificial intelligence (AI) chatbot is provided that allows the user to verbalize natural language queries about real-world objects in the view. For example, as user may be looking at a view of their kitchen and their countertop has two different snacks on it. The user may look at the two snacks and wish to find out which of the two snacks is healthier. Ideally the interface would provide some mechanism for the user to signify that it is the two snacks that the user is interested as using as context for the query (and not, for example, other real world objects from the user's kitchen that are visible in the view).

It is also desirable to provide an interface for capture and to provide feedback to the user on what was actually captured. This provides more information to the user about what they are actually sending as context to a query to, for example, a 3^{rd} party artificial intelligence (AI) service. This helps allow a user to gain more control over their choice to share their visual data with computing providers, and also provides a possibility of a review step in case they actually captured something unintentionally and do not wish to share that captured data. Thus, this provides more visibility to the users for their own data privacy decisions.

This aspect is especially important on a head-wearable apparatus, where the capture field of view may not match the visible display area, in contrast to more traditional cameras or mobile devices where typically the user has more control over the entire field of view and the user captures the entire field of view. In a head-wearable apparatus, framing the capture composition typically happens from the user's head position, and controlling that is a new skill that is less familiar to users, and thus they may not accurately perform the framing of their intended subject.

Implementation of such an interface, however, is technically challenging. In a single view there may be tens or even hundreds of items that a user may potentially wish to ask a question about or involving, and in a head-wearable apparatus there may not be the same level of precise control of selections the way there is when, for example, using a mouse on a desktop or laptop computer.

In an example, two different mechanisms for specifying a real-world object visible in a view are provided. Each of these different mechanisms has their own benefits, and indeed in another example a hybrid of the two mechanisms may be used, where a user can seamlessly switch between mechanisms based on their own desires or scenarios.

For ease of discussion, the act of identifying a particular real-world object within an XR view will be called “snapping” or “taking a snap”.

The first mechanism is called a hand-tracked viewfinder. Here, a viewfinder is displayed around the user's dominant hand in the XR view. The user can then move the hand so that the viewfinder is over the object or objects of interest, and then the user makes a pinching motion with a dominant hand within the XR view on an object or group of objects the user is interested in snapping. A pinching motion may be defined as moving one of the fingers, most commonly the index finger, of the dominant hand to touch the thumb of the dominant hand. The location where the user's finger touches the user's thumb may indicate the snap location (e.g., take a snap of the object behind the location where the finger touches the thumb). The object or objects selected are then “snapped”, with the viewfinder transitioning to a similar box indicating that a capture has been taken. This visual indicator can be a valuable tool in that it allows, for example, the user to cancel the snap if the system is attempting to snap a different object or objects than the user intended.

This allows for more precise framing of the intended subject, as the head-wrist of a user is more flexible than the head/neck. The interaction itself is also more similar to traditional mechanisms of subject capture, such as mobile devices, which involve the use of the user's hand.

The second mechanism is called a head-tracked viewfinder. Here, a viewfinder window automatically forms around an object in or near the center of the view, allowing the user to simply “look” at an object for a snap to occur. The actual snap of the image may be triggered, for example, by the user ceasing to speak to the AI chatbot. Thus, for example, a user may look at a bowl of cereal and ask “How many calories are in this?.” Once the end of that verbal command is received (as indicated by, for example, some period of time passing with no words being uttered by the user), the object in the viewfinder is snapped. The advantage of this approach is that it is hands-free, although it may not be as precise as the hand-tracked viewfinder approach. Nevertheless, it also has the same benefit of the viewfinder transitioning to a similar box indicating that a capture has been taken, which again is a valuable tool in that it allows, for example, the user to cancel the snap if the system is attempting to snap a different object or objects than the user intended.

The lack of the need to use the hands may be important since it allows the user to capture subjects even when the user's hands are occupied, either with real-world objects (such as carrying objects) or with other user interface aspects, such as performing a questioning task. It also requires less physical effort than using the hand as the head can remain relatively neutral and still produce an accurate enough capture.

Both of these viewfinders may be opt-in, and specifically may be activated through, for example, selecting a camera button or a voice request asking a question about or related to an object.

As mentioned earlier, a hybrid approach is also provided, where the hand-tracked viewfinder is utilized when the dominant hand of the user is within the view of the XR experience (e.g., visible to the user wearing the head-wearable device), while the head-tracked viewfinder is utilized when the dominant hand of the user is not within the view of the XR experience (e.g., not visible to the user wearing the head-wearable device).

The hybrid approach means the user does not have to consciously choose a mode. If the user is already used to using their hands they can continue to do so while also learning how to use their head/neck for the same purpose.

Other technical features can be readily apparent to one skilled in the art from the following figures, descriptions, and claims.

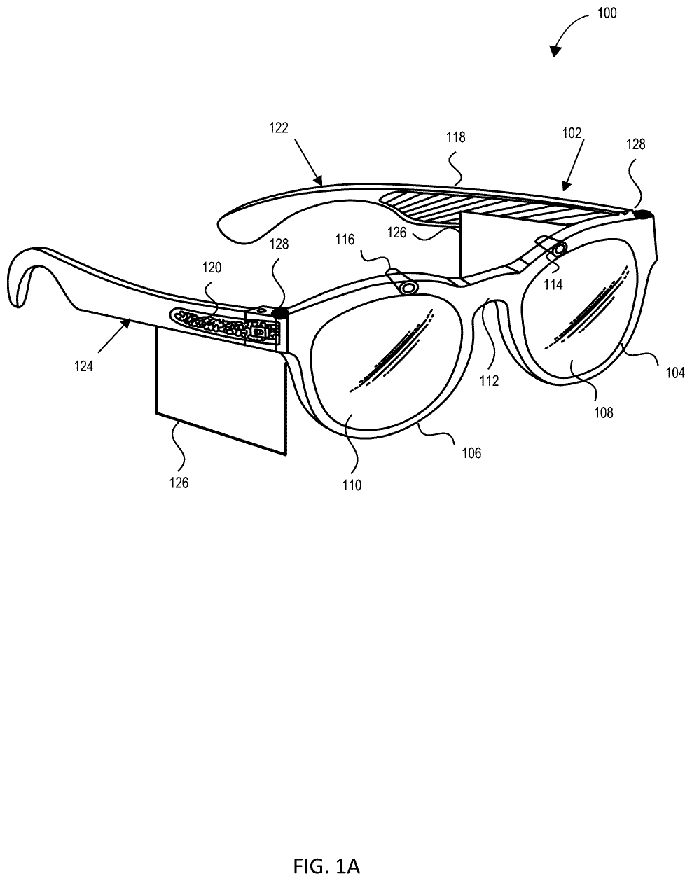

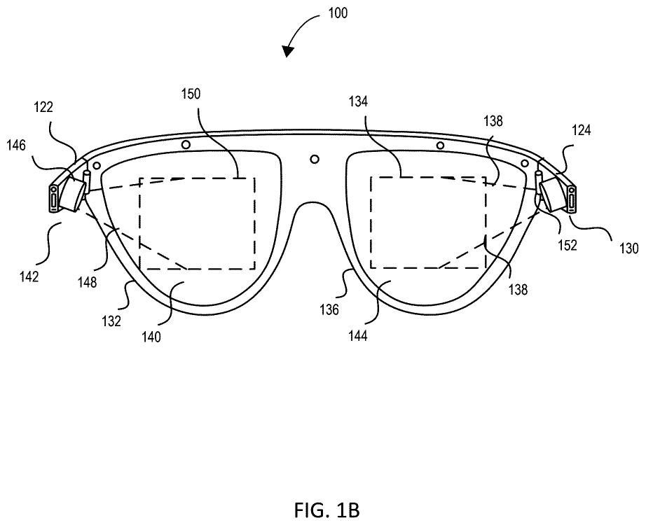

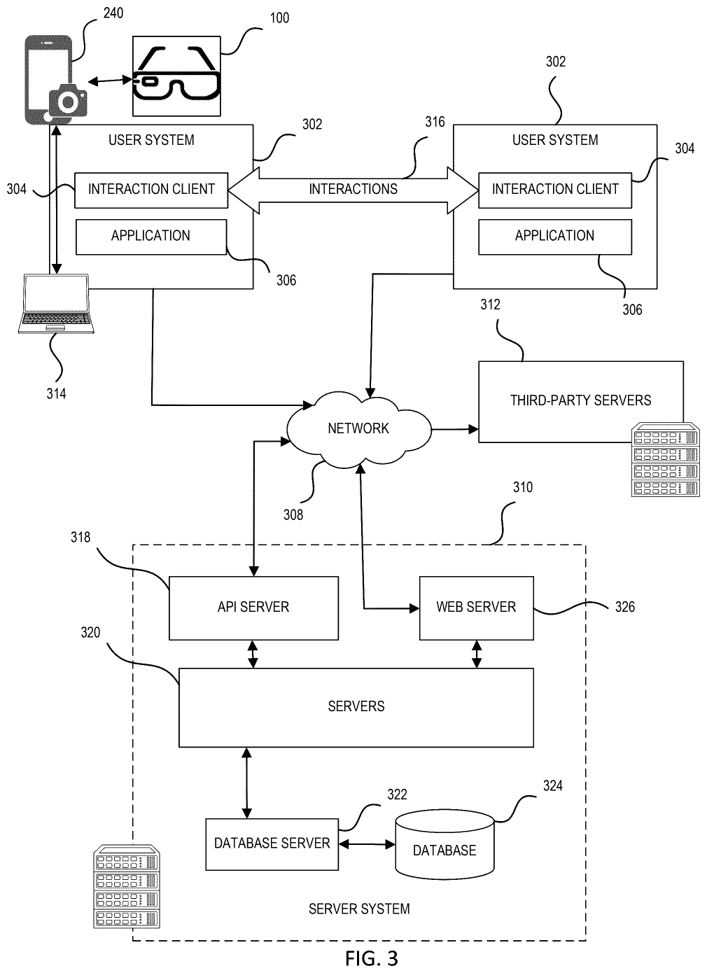

FIG. 1A is a perspective view of a head-wearable apparatus 100 according to some examples. The head-wearable apparatus 100 can be a client device of an XR system, such as a user system 302 of FIG. 3. The head-wearable apparatus 100 can include a frame 102 made from any suitable material such as plastic or metal, including any suitable shape memory alloy. In one or more examples, the frame 102 includes a first or left optical element holder 104 (e.g., a display or lens holder) and a second or right optical element holder 106 connected by a bridge 112. A first or left optical element 108 and a second or right optical element 110 can be provided within respective left optical element holder 104 and right optical element holder 106. The right optical element 110 and the left optical element 108 can be a lens, a display, a display assembly, or a combination of the foregoing. Any suitable display assembly can be provided in the head-wearable apparatus 100.

The frame 102 additionally includes a left arm or left temple piece 122 and a right arm or right temple piece 124. In some examples, the frame 102 can be formed from a single piece of material so as to have a unitary or integral construction.

The head-wearable apparatus 100 can include a computing device, such as a computer 120, which can be of any suitable type so as to be carried by the frame 102 and, in one or more examples, of a suitable size and shape, so as to be partially disposed in one of the left temple piece 122 or the right temple piece 124. The computer 120 can include one or more processors with memory, wireless communication circuitry, and a power source. As discussed below, the computer 120 comprises low-power circuitry 224, high-speed circuitry 226, and a display processor. Various other examples can include these elements in different configurations or integrated together in different ways. Additional details of aspects of the computer 120 can be implemented as illustrated by the machine 400 discussed herein.

The computer 120 additionally includes a battery 118 or other suitable portable power supply. In some examples, the battery 118 is disposed in left temple piece 122 and is electrically coupled to the computer 120 disposed in the right temple piece 124. The head-wearable apparatus 100 can include a connector or port (not shown) suitable for charging the battery 118, a wireless receiver, transmitter or transceiver (not shown), or a combination of such devices.

The head-wearable apparatus 100 includes a first or left camera 114 and a second or right camera 116. Although two cameras are depicted, other examples contemplate the use of a single or additional cameras (e.g., two or more cameras).

In some examples, the head-wearable apparatus 100 includes any number of input sensors or other input/output devices in addition to the left camera 114 and the right camera 116. Such sensors or input/output devices can additionally include biometric sensors, location sensors, motion sensors, and so forth.

In some examples, the left camera 114 and the right camera 116 provide tracking image data for use by the head-wearable apparatus 100 to extract 3D information from a real-world scene.

The head-wearable apparatus 100 can also include a touchpad 126 mounted to or integrated with one or both of the left temple piece 122 and right temple piece 124. The touchpad 126 is generally vertically-arranged, approximately parallel to a user's temple in some examples. As used herein, generally vertically aligned means that the touchpad is more vertical than horizontal, although potentially more vertical than that. Additional user input can be provided by one or more buttons 128, which in the illustrated examples are provided on the outer upper edges of the left optical element holder 104 and right optical element holder 106. The one or more touchpads 126 and buttons 128 provide a means whereby the head-wearable apparatus 100 can receive input from a user of the head-wearable apparatus 100.

FIG. 1B illustrates the head-wearable apparatus 100 from the perspective of a user while wearing the head-wearable apparatus 100. For clarity, a number of the elements shown in FIG. 1A have been omitted. As described in FIG. 1A, the head-wearable apparatus 100 shown in FIG. 1B includes left optical element 140 and right optical element 144 secured within the left optical element holder 132 and the right optical element holder 136 respectively.

The head-wearable apparatus 100 includes right forward optical assembly 130 comprising a left near eye display 150, a right near eye display 134, and a left forward optical assembly 142 including a left projector 146 and a right projector 152.

In some examples, the near eye displays are waveguides. The waveguides include reflective or diffractive structures (e.g., gratings and/or optical elements such as mirrors, lenses, or prisms). Light 138 emitted by the right projector 152 encounters the diffractive structures of the waveguide of the right near eye display 134, which directs the light towards the right eye of a user to provide an image on or in the right optical element 144 that overlays the view of the real-world scene seen by the user. Similarly, light 148 emitted by the left projector 146 encounters the diffractive structures of the waveguide of the left near eye display 150, which directs the light towards the left eye of a user to provide an image on or in the left optical element 140 that overlays the view of the real-world scene seen by the user. The combination of a Graphical Processing Unit, an image display driver, the right forward optical assembly 130, the left forward optical assembly 142, left optical element 140, and the right optical element 144 provide an optical engine of the head-wearable apparatus 100. The head-wearable apparatus 100 uses the optical engine to generate an overlay of the real-world scene view of the user including display of a user interface to the user of the head-wearable apparatus 100.

It will be appreciated however that other display technologies or configurations can be utilized within an optical engine to display an image to a user in the user's field of view. For example, instead of a projector and a waveguide, an LCD, LED or other display panel or surface can be provided.

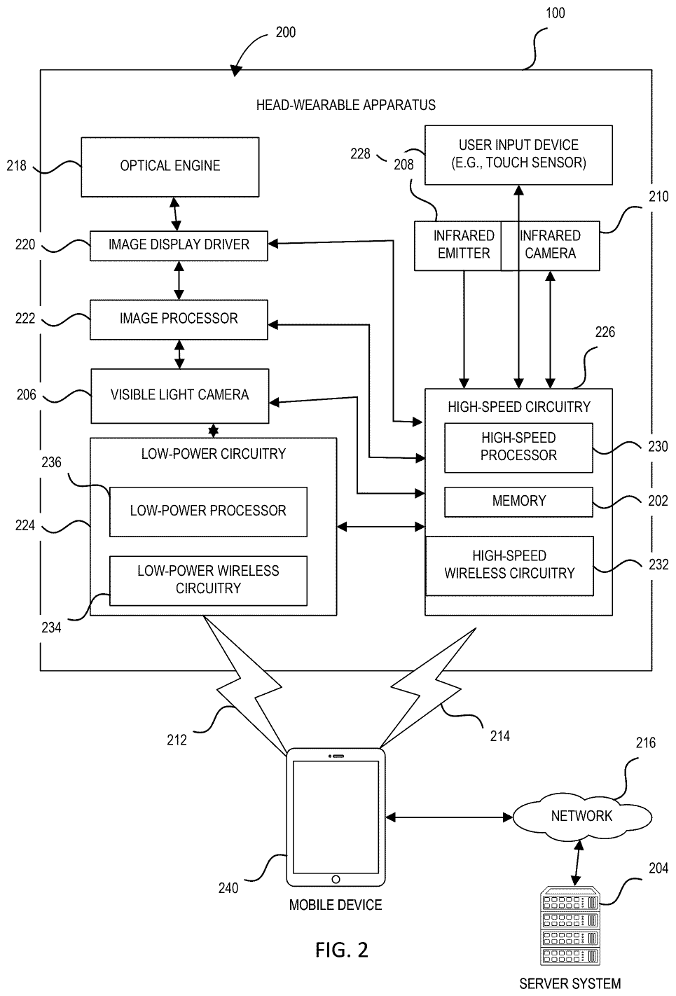

In use, a user of the head-wearable apparatus 100 will be presented with information, content and various user interfaces on the near eye displays. As described in more detail herein, the user can then interact with the head-wearable apparatus 100 using a touchpad 126 and/or the button 128, voice inputs or touch inputs on an associated device (e.g. mobile device 240 illustrated in FIG. 2), and/or hand movements, locations, and positions recognized by the head-wearable apparatus 100.

In some examples, an optical engine of an XR system is incorporated into a lens that is in contact with a user's eye, such as a contact lens or the like. The XR system generates images of an XR experience using the contact lens.

In some examples, the head-wearable apparatus 100 comprises an XR system. In some examples, the head-wearable apparatus 100 is a component of an XR system including additional computational components. In some examples, the head-wearable apparatus 100 is a component in an XR system comprising additional user input systems or devices.

FIG. 2 illustrates a system 200 including a head-wearable apparatus 100 with a selector input device, according to some examples. FIG. 2 is a high-level functional block diagram of an example head-wearable apparatus 100 communicatively coupled to a mobile device 240 and various server systems 204 via various communications mediums 212, 214.

The head-wearable apparatus 100 includes one or more cameras, each of which can be, for example, a visible light camera 206, an infrared emitter 208, and an infrared camera 210.

The mobile device 240 connects with head-wearable apparatus 100 using both a low-power wireless connection 212 and a high-speed wireless connection 214. The mobile device 240 is also connected to the server system 204 and the networks 216.

The head-wearable apparatus 100 further includes one or more image displays of the optical engine 218. The optical engines 218 include one associated with the left lateral side and one associated with the right lateral side of the head-wearable apparatus 100. The head-wearable apparatus 100 also includes an image display driver 220, an image processor 222, low-power circuitry 224, and high-speed circuitry 226. The optical engine 218 is for presenting images and videos, including an image that can include a graphical user interface to a user of the head-wearable apparatus 100.

The image display driver 220 commands and controls the optical engine 218. The image display driver 220 can deliver image data directly to the optical engine 218 for presentation or can convert the image data into a signal or data format suitable for delivery to the image display device. For example, the image data can be video data formatted according to compression formats, such as H.264 (MPEG-4 Part 10), HEVC, Theora, Dirac, RealVideo RV40, VP8, VP9, or the like, and still image data can be formatted according to compression formats such as Portable Network Group (PNG), Joint Photographic Experts Group (JPEG), Tagged Image File Format (TIFF) or exchangeable image file format (EXIF) or the like.

The head-wearable apparatus 100 includes a frame and stems (or temples) extending from a lateral side of the frame. The head-wearable apparatus 100 further includes a user input device 228 (e.g., touch sensor or push button), including an input surface on the head-wearable apparatus 100. The user input device 228 (e.g., touch sensor or push button) is to receive from the user an input selection to manipulate the graphical user interface of the presented image.

The components shown in FIG. 2 for the head-wearable apparatus 100 are located on one or more circuit boards, for example a PCB or flexible PCB, in the rims or temples. Alternatively, or additionally, the depicted components can be located in the chunks, frames, hinges, or bridge of the head-wearable apparatus 100. Left and right visible light cameras 206 can include digital camera elements such as a complementary metal oxide-semiconductor (CMOS) image sensor, charge-coupled device, camera lenses, or any other respective visible or light-capturing elements that can be used to capture data, including images of scenes with unknown objects.

The head-wearable apparatus 100 includes a memory 202, which stores instructions to perform a subset, or all the functions described herein. The memory 202 can also include storage device.

As shown in FIG. 2, the high-speed circuitry 226 includes a high-speed processor 230, a memory 202, and high-speed wireless circuitry 232. In some examples, the image display driver 220 is coupled to the high-speed circuitry 226 and operated by the high-speed processor 230 to drive the left and right image displays of the optical engine 218. The high-speed processor 230 can be any processor capable of managing high-speed communications and operation of any general computing system needed for the head-wearable apparatus 100. The high-speed processor 230 includes processing resources needed for managing high-speed data transfers on a high-speed wireless connection 214 to a wireless local area network (WLAN) using the high-speed wireless circuitry 232. In certain examples, the high-speed processor 230 executes an operating system such as a LINUX operating system or other such operating system of the head-wearable apparatus 100, and the operating system is stored in the memory 202 for execution. In addition to any other responsibilities, the high-speed processor 230 executing a software architecture for the head-wearable apparatus 100 is used to manage data transfers with high-speed wireless circuitry 232. In certain examples, the high-speed wireless circuitry 232 is configured to implement Institute of Electrical and Electronic Engineers (IEEE) 802.11 communication standards, also referred to herein as WI-FI®. In some examples, other high-speed communications standards can be implemented by the high-speed wireless circuitry 232.

The low-power wireless circuitry 234 and the high-speed wireless circuitry 232 of the head-wearable apparatus 100 can include short-range transceivers (e.g., Bluetooth™, Bluetooth LE, Zigbee, ANT+) and wireless wide, local, or wide area Network transceivers (e.g., cellular or WI-FI®). Mobile device 240, including the transceivers communicating via the low-power wireless connection 212 and the high-speed wireless connection 214, can be implemented using details of the architecture of the head-wearable apparatus 100, as can other elements of the network 216.

The memory 202 includes any storage device capable of storing various data and applications, including, among other things, camera data generated by the left and right visible light cameras 206, the infrared camera 210, and the image processor 222, as well as images generated for display by the image display driver 220 on the image displays of the optical engine 218. While the memory 202 is shown as integrated with high-speed circuitry 226, in some examples, the memory 202 can be an independent standalone element of the head-wearable apparatus 100. In certain such examples, electrical routing lines can provide a connection through a chip that includes the high-speed processor 230 from the image processor 222 or the low-power processor 236 to the memory 202. In some examples, the high-speed processor 230 can manage addressing of the memory 202 such that the low-power processor 236 will boot the high-speed processor 230 any time that a read or write operation involving memory 202 is needed.

As shown in FIG. 2, the low-power processor 236 or high-speed processor 230 of the head-wearable apparatus 100 can be coupled to the camera (visible light camera 206, infrared emitter 208, or infrared camera 210), the image display driver 220, the user input device 228 (e.g., touch sensor or push button), and the memory 202.

The head-wearable apparatus 100 is connected to a host computer. For example, the head-wearable apparatus 100 is paired with the mobile device 240 via the high-speed wireless connection 214 or connected to the server system 204 via the network 216. The server system 204 can be one or more computing devices as part of a service or network computing system, for example, that includes a processor, a memory, and network communication interface to communicate over the network 216 with the mobile device 240 and the head-wearable apparatus 100.

The mobile device 240 includes a processor and a Network communication interface coupled to the processor. The Network communication interface allows for communication over the network 216, low-power wireless connection 212, or high-speed wireless connection 214. The mobile device 240 can further store at least portions of the instructions in the memory of the mobile device 240 memory to implement the functionality described herein.

Output components of the mobile device 240 include visual components, such as a display such as a liquid crystal display (LCD), a plasma display panel (PDP), a light-emitting diode (LED) display, a projector, or a waveguide. The image displays of the optical assembly are driven by the image display driver 220. The output components of the mobile device 240 further include acoustic components (e.g., speakers), haptic components (e.g., a vibratory motor), other signal generators, and so forth. The input components of the mobile device 240, the mobile device 240, and server system 204, such as the user input device 228, can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 100 can also include additional peripheral device elements. Such peripheral device elements can include sensors and display elements integrated with the head-wearable apparatus 100. For example, peripheral device elements can include any I/O components including output components, motion components, position components, or any other such elements described herein.

In some examples, the head-wearable apparatus 100 can include biometric components or sensors to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components can include a brain-machine interface (BMI) system that allows communication between the brain and an external device or machine. This can be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored with only user approval and deleted on user request, and in accordance with applicable laws. Further, such biometric data can be used for very limited purposes, such as identification verification. To ensure limited and authorized use of biometric information and other personally identifiable information (PII), access to this data is restricted to authorized personnel only, if at all. Any use of biometric data can strictly be limited to identification verification purposes, and the biometric data is not shared or sold to any third party without the explicit consent of the user. In addition, appropriate technical and organizational measures are implemented to ensure the security and confidentiality of this sensitive information.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude can be derived), orientation sensor components (e.g., magnetometers), and the like. Such positioning system coordinates can also be received over low-power wireless connections 212 and high-speed wireless connection 214 from the mobile device 240 via the low-power wireless circuitry 234 or high-speed wireless circuitry 232.

FIG. 3 is a block diagram showing an example digital interaction system 300 for facilitating interactions and engagements (e.g., exchanging text messages, conducting text audio and video calls, or playing games) over a network. The digital interaction system 300 includes multiple user systems 302, each of which hosts multiple applications, including an interaction client 304 and other applications 306. Each interaction client 304 is communicatively coupled, via one or more networks including a network 308 (e.g., the Internet), to other instances of the interaction client 304 (e.g., hosted on respective other user systems), a server system 310 and third-party servers 312). An interaction client 304 can also communicate with locally hosted applications 306 using Applications Program Interfaces (APIs).

Each user system 302 can include multiple user devices, such as a mobile device 240, head-wearable apparatus 100, and a computer client device 314 that are communicatively connected to exchange data and messages.

An interaction client 304 interacts with other interaction clients 304 and with the server system 310 via the network 308. The data exchanged between the interaction clients 304 (e.g., interactions 316) and between the interaction clients 304 and the server system 310 includes functions (e.g., commands to invoke functions) and payload data (e.g., text, audio, video, or other multimedia data).

The server system 310 provides server-side functionality via the network 308 to the interaction clients 304. While certain functions of the digital interaction system 300 are described herein as being performed by either an interaction client 304 or by the server system 310, the location of certain functionality either within the interaction client 304 or the server system 310 can be a design choice. For example, it can be technically preferable to initially deploy particular technology and functionality within the server system 310 but to later migrate this technology and functionality to the interaction client 304 where a user system 302 has sufficient processing capacity.

The server system 310 supports various services and operations that are provided to the interaction clients 304. Such operations include transmitting data to, receiving data from, and processing data generated by the interaction clients 304. This data can include message content, client device information, geolocation information, digital effects (e.g., media augmentation and overlays), message content persistence conditions, entity relationship information, and live event information. Data exchanges within the digital interaction system 300 are invoked and controlled through functions available via user interfaces (UIs) of the interaction clients 304.

Turning now specifically to the server system 310, an Application Program Interface (API) server 318 is coupled to and provides programmatic interfaces to servers 320, making the functions of the servers 320 accessible to interaction clients 304, other applications 306 and third-party server 312. The servers 320 are communicatively coupled to a database server 322, facilitating access to a database 324 that stores data associated with interactions processed by the servers 320. Similarly, a web server 326 is coupled to the servers 320 and provides web-based interfaces to the servers 320. To this end, the web server 326 processes incoming network requests over the Hypertext Transfer Protocol (HTTP) and several other related protocols.

The Application Program Interface (API) server 318 receives and transmits interaction data (e.g., commands and message payloads) between the servers 320 and the user systems 302 (and, for example, interaction clients 304 and other application 306) and the third-party server 312. Specifically, the Application Program Interface (API) server 318 provides a set of interfaces (e.g., routines and protocols) that can be called or queried by the interaction client 304 and other applications 306 to invoke functionality of the servers 320. The Application Program Interface (API) server 318 exposes various functions supported by the servers 320, including account registration; login functionality; the sending of interaction data, via the servers 320, from a particular interaction client 304 to another interaction client 304; the communication of media files (e.g., images or video) from an interaction client 304 to the servers 320; the settings of a collection of media data (e.g., a narrative); the retrieval of a list of friends of a user of a user system 302; the retrieval of messages and content; the addition and deletion of entities (e.g., friends) to an entity relationship graph; the location of friends within an entity relationship graph; and opening an application event (e.g., relating to the interaction client 304).

The interaction client 304 provides a user interface that allows users to access features and functions of an external resource, such as a linked application 306, an applet, or a microservice. This external resource can be provided by a third party or by the creator of the interaction client 304.

The external resource can be a full-scale application installed on the user's system 302, or a smaller, lightweight version of the application, such as an applet or a microservice, hosted either on the user's system or remotely, such as on third-party servers 312 or in the cloud. These smaller versions, which include a subset of the full application's features, can be implemented using a markup-language document and can also incorporate a scripting language and a style sheet.

When a user selects an option to launch or access the external resource, the interaction client 304 determines whether the resource is web-based or a locally installed application. Locally installed applications can be launched independently of the interaction client 304, while applets and microservices can be launched or accessed via the interaction client 304.

If the external resource is a locally installed application, the interaction client 304 instructs the user's system to launch the resource by executing locally stored code. If the resource is web-based, the interaction client 304 communicates with third-party servers to obtain a markup-language document corresponding to the selected resource, which it then processes to present the resource within its user interface.

The interaction client 304 can also notify users of activity in one or more external resources. For instance, it can provide notifications relating to the use of an external resource by one or more members of a user group. Users can be invited to join an active external resource or to launch a recently used but currently inactive resource.

The interaction client 304 can present a list of available external resources to a user, allowing them to launch or access a given resource. This list can be presented in a context-sensitive menu, with icons representing different applications, applets, or microservices varying based on how the menu is launched by the user.

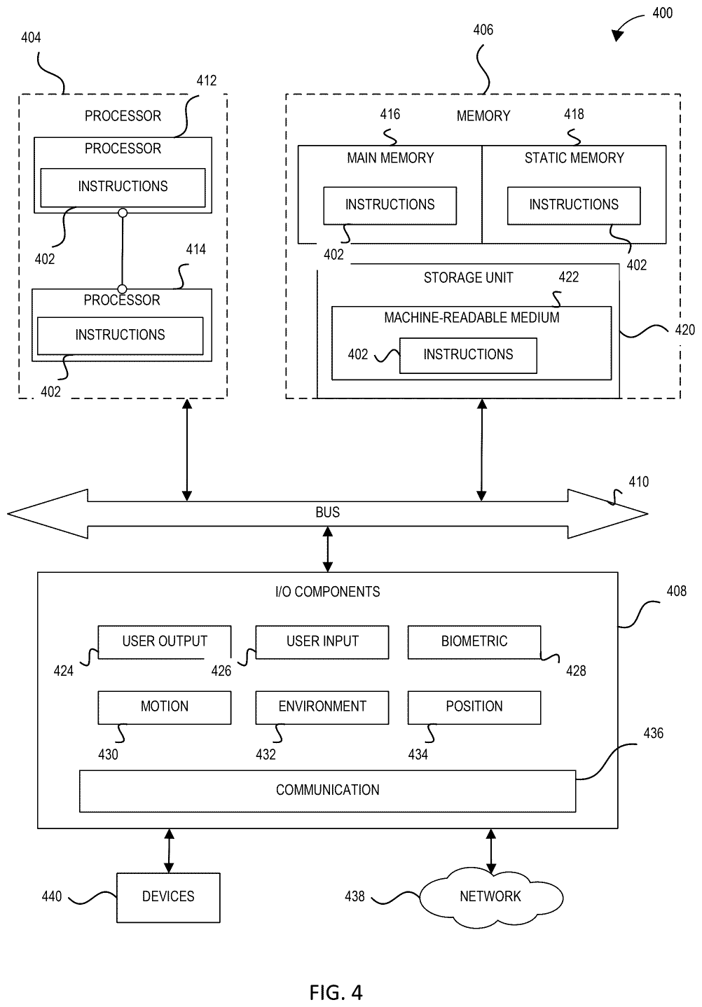

FIG. 4 is a diagrammatic representation of the machine 400 within which instructions 402 (e.g., software, a program, an application, an applet, an app, or other executable code) for causing the machine 400 to perform any one or more of the methodologies discussed herein can be executed. For example, the instructions 402 can cause the machine 400 to execute any one or more of the methods described herein. The instructions 402 transform the general, non-programmed machine 400 into a particular machine 400 programmed to carry out the described and illustrated functions in the manner described. The machine 400 can operate as a standalone device or can be coupled (e.g., networked) to other machines. In a networked deployment, the machine 400 can operate in the capacity of a server machine or a client machine in a server-client network environment, or as a peer machine in a peer-to-peer (or distributed) network environment. The machine 400 can comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 402, sequentially or otherwise, that specify actions to be taken by the machine 400. Further, while a single machine 400 is illustrated, the term “machine” shall also be taken to include a collection of machines that individually or jointly execute the instructions 402 to perform any one or more of the methodologies discussed herein. The machine 400, for example, can comprise the user system 302 or any one of multiple server devices forming part of the server system 310. In some examples, the machine 400 can also comprise both client and server systems, with certain operations of a particular method or algorithm being performed on the server-side and with certain operations of the method or algorithm being performed on the client-side.

The machine 400 can include one or more hardware processors 404, memory 406, and input/output I/O components 408, which can be configured to communicate with each other via a bus 410.

The processor 404 can comprise one or more processors such as, but not limited to, processor 412 and processor 414. The one or more processors can comprise one or more types of processing systems such as, but not limited to, Central Processing Units (CPUs), Graphics Processing Units (GPUs), Digital Signal Processors (DSPs), Neural Processing Units (NPUs) or AI Accelerators, Physics Processing Units (PPUs), Field-Programmable Gate Arrays (FPGAs), Multi-core Processors, Symmetric Multiprocessing (SMP) Systems, and the like.

The memory 406 includes a main memory 416, a static memory 418, and a storage unit 420, both accessible to the processor 404 via the bus 410. The main memory 406, the static memory 418, and storage unit 420 store the instructions 402 embodying any one or more of the methodologies or functions described herein. The instructions 402 can also reside, completely or partially, within the main memory 416, within the static memory 418, within machine-readable medium 422 within the storage unit 420, within at least one of the processor 404 (e.g., within the processor's cache memory), or any suitable combination thereof, during execution thereof by the machine 400.

The I/O components 408 can include a wide variety of components to receive input, provide output, produce output, transmit information, exchange information, capture measurements, and so on. The specific I/O components 408 that are included in a particular machine will depend on the type of machine. For example, portable machines such as mobile phones can include a touch input device or other such input mechanisms, while a headless server machine will likely not include such a touch input device. It will be appreciated that the I/O components 408 can include many other components that are not shown in FIG. 4. In various examples, the I/O components 408 can include user output components 424 and user input components 426. The user output components 424 can include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 426 can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 408 can include biometric components 428, motion components 430, environmental components 432, or position components 434, among a wide array of other components. For example, the biometric components 428 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components can include a brain-machine interface (BMI) system that allows communication between the brain and an external device or machine. This can be achieved by recording brain activity data, translating this data into a format that can be understood by a computer, and then using the resulting signals to control the device or machine.

Any biometric data collected by the biometric components is captured and stored only with user approval and deleted on user request, and in accordance with applicable laws. Further, such biometric data can be used for very limited purposes, such as identification verification. To ensure limited and authorized use of biometric information and other Personally Identifiable Information (PII), access to this data is restricted to authorized personnel only, if at all. Any use of biometric data can strictly be limited to identification verification purposes, and the data is not shared or sold to any third party without the explicit consent of the user. In addition, appropriate technical and organizational measures are implemented to ensure the security and confidentiality of this sensitive information.

The motion components 430 include acceleration sensor components (e.g., accelerometer), gravitation sensor components, rotation sensor components (e.g., gyroscope).

The environmental components 432 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that can provide indications, measurements, or signals corresponding to a surrounding physical environment.

With respect to cameras, the user system 302 can have a camera system comprising, for example, front cameras on a front surface of the user system 302 and rear cameras on a rear surface of the user system 302. The front cameras can, for example, be used to capture still images and video of a user of the user system 302 (e.g., “selfies”), which can then be modified with digital effect data (e.g., filters) described above. The rear cameras can, for example, be used to capture still images and videos in a more traditional camera mode, with these images similarly being modified with digital effect data. In addition to front and rear cameras, the user system 302 can also include a 360° camera for capturing 360° photographs and videos.

Moreover, the camera system of the user system 302 can be equipped with advanced multi-camera configurations. This can include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 302 can also feature triple, quad, or even penta camera configurations on both the front and rear sides of the user system 302. These multiple cameras systems can include a wide camera, an ultra-wide camera, a telephoto camera, a macro camera, and a depth sensor, for example.

Communication can be implemented using a wide variety of technologies. The I/O components 408 further include communication components 436 operable to couple the machine 400 to a Network 438 or devices 440 via respective coupling or connections. For example, the communication components 436 can include a network interface component or another suitable device to interface with the Network 438. In further examples, the communication components 436 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 440 can be another machine or any of a wide variety of peripheral devices (e.g., a peripheral device coupled via a USB).

Moreover, the communication components 436 can detect identifiers or include components operable to detect identifiers. For example, the communication components 436 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information can be derived via the communication components 436, such as location via Internet Protocol (IP) geolocation, location via Wi-Fi® signal triangulation, location via detecting an NFC beacon signal that can indicate a particular location, and so forth.

The various memories (e.g., main memory 416, static memory 418, and memory of the processor 404) and storage unit 420 can store one or more sets of instructions and data structures (e.g., software) embodying or used by any one or more of the methodologies or functions described herein. These instructions (e.g., the instructions 402), when executed by processor 404, cause various operations to implement the disclosed examples.

The instructions 402 can be transmitted or received over the Network 438, using a transmission medium, via a network interface device (e.g., a network interface component included in the communication components 436) and using any one of several well-known transfer protocols (e.g., hypertext transfer protocol (HTTP)). Similarly, the instructions 402 can be transmitted or received using a transmission medium via a coupling (e.g., a peer-to-peer coupling) to the devices 440.

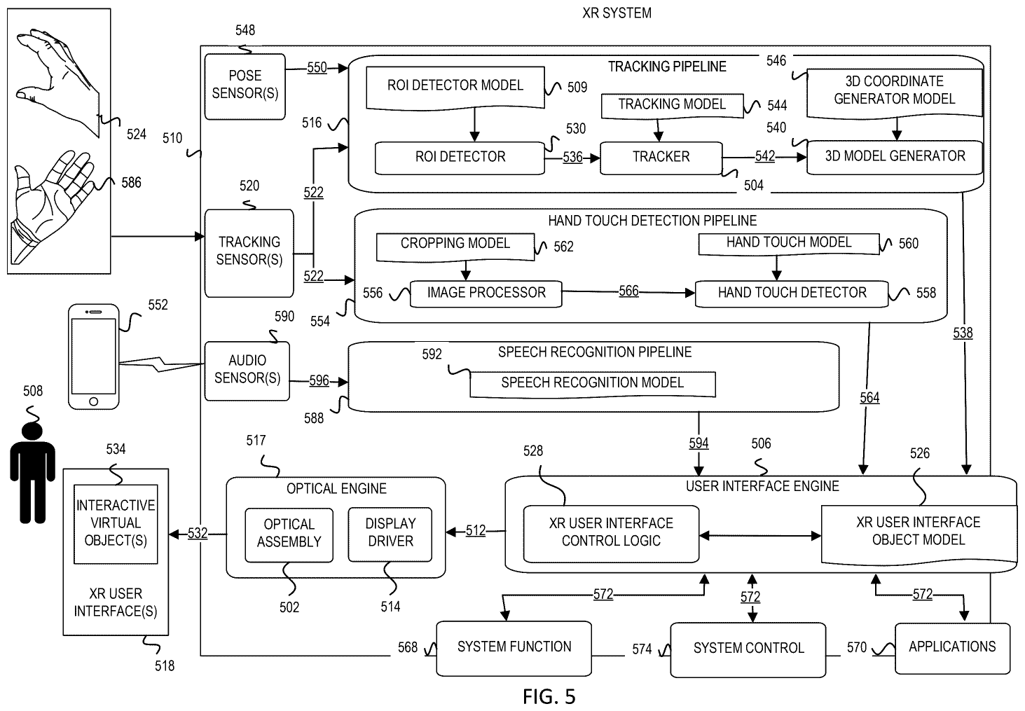

FIG. 5 illustrates a collaboration diagram of components of an XR system 510, such as head-wearable apparatus 100 of FIG. 1A, using hand-tracking for user input, according to some examples.

The XR system 510 uses 3D tracking data 538 and hand touch data 564 to provide a continuous real-time input modalities to a user 508 of the XR system 510 where the user 508 interacts with one or more XR user interfaces 518 using hand-tracking and hand touch input modalities. Using the hand-tracking and hand touch input modalities, the XR system 510 generates user interface input/output (UI I/O) data 572 that are used by a system control component 574, one or more system function components system function component 568, and one or more applications 570 to generate one or more interactive user interfaces displayed as part of the one or more XR user interfaces 518.

The applications 570 are applications that are executed by the XR system 510 and generate application user interfaces that provide features such as, but not limited to, maintenance guides, interactive maps, interactive tour guides, tutorials, and the like. The applications 570 can also be entertainment applications such as, but not limited to, video games, interactive videos, and the like.

The system function components 568 provide system function user interfaces that a user can use to perform various system-level functions. These system-level functions can include, but are not limited to:

Hand-Tracking and Hand touch Recognition Management: Manages configuration of the user input systems, providing real-time feedback through the system function user interface.

Contextual Help and Tips: Offers contextual help and tips providing relevant assistance based on the user's current activities.

Notification Management: Manages notifications and alerts, ensuring they are presented in a non-intrusive manner and allowing customization of notification settings.

User Customization Settings: Allows users to customize various system settings, including gesture sensitivity and display settings.

Application Management: Handles the launching, switching, and closing of applications, providing a seamless interaction with multiple applications.

Real-Time System Status Updates: Provides real-time updates on system status, such as battery life and connection status.

Security and Privacy Controls: Manages security settings and privacy controls, allowing users to configure these settings and providing prompts about security and privacy issues.

The system control component 574 provides one or more system control user interfaces that provide a consistent user interface for controlling the operating system of the XR system.

The XR system 510 generates a XR user interface 518 provided to the user 508 within an XR environment. The XR user interface 518 includes one or more interactive virtual objects 534 that the user 508 can interact with. For example, a user interface engine 506 of FIG. 5 includes XR user interface control logic 528 comprising a dialog script or the like that specifies a user interface dialog implemented by the XR user interface 518. The XR user interface control logic 528 also comprises one or more actions that are to be taken by the XR system 510 based on detecting various dialog events such as user inputs input by the user 508 using the XR user interface 518 and by making hand gestures. The user interface engine 506 further includes an XR user interface object model 526. The XR user interface object model 526 includes 3D coordinate data of the one or more XR user interfaces 518 and the one or more interactive virtual objects 534. The 3D graphics data is used by an optical engine 517 to generate the XR user interface 518 provided to the user 508.

The user interface engine 506 generates XR user interface data 512 using the XR user interface object model 526. The XR user interface data 512 includes image data of the one or more interactive virtual objects 534 of the XR user interface 518. The user interface engine 506 communicates the XR user interface data 512 to a display driver 514 of an optical engine 517 of the XR system 510. The display driver 514 receives the XR user interface data 512 and generates display control signals using the XR user interface data 512. The display driver 514 uses the display control signals to control the operations of one or more optical assemblies 502 of the optical engine 517. In response to the display control signals, the one or more optical assemblies 502 generate an XR user interface graphics display 532 of the XR user interface 518 provided to the user 508.

While in use, the XR system 510 uses one or more tracking sensors 520 to detect and record a position, orientation, and gestures of the hands 524 of the user 508. This can involve capturing the speed and trajectory of hand movements, recognizing specific hand poses, and determining the relative positioning of the hands in the three-dimensional space of an XR environment.

In some examples, the one or more tracking sensors 520 comprise an array of optical sensors capable of capturing a wide range of hand movements and gestures in real-time as images. These sensors can include Red Green and Blue (RGB) cameras that capture images of the hands 524 of the user 508 using light having a broad wavelength spectrum, such as natural light provided by the real-world environment or artificial illumination created by one or more incandescent lamps, LED lamps, or the like provided by the XR system 510. In some examples, the one or more tracking sensors 520 can include infrared cameras that capture images of the hands 524 of the user 508 using energy in the infrared radiation (IR) spectrum. The IR energy can be supplied by one or more IR emitters of the XR system 510.

In some examples, the one or more tracking sensors 520 comprise depth-sensing cameras that utilize structured light or time-of-flight technology to create a three-dimensional model of the hands 524 of the user 508. This allows the XR system 510 to detect intricate gestures and finger movements with high accuracy.

In some examples, the one or more tracking sensors 520 comprise ultrasonic sensors that emit sound waves and measure the reflection off the hands 524 of the user 508 to determine their location and movement in space.

In some examples, the one or more tracking sensors 520 comprise electromagnetic field sensors that track the movement of the hands 524 of the user 508 by detecting changes in an electromagnetic field generated around the user 508.

In some examples, the one or more tracking sensors 520 include capacitive sensors embedded in gloves worn by the user 508. These sensors detect hand movements and gestures based on changes in capacitance caused by finger positioning and orientation.

In some examples, the XR system 510 includes one or more pose sensors 548 such as an Inertial Measurement Unit (IMU) and the like, that track the orientation and movements of the XR system of the user 508. The one or more pose sensors 548 are used to determine Six Degrees of Freedom (6DoF) data of movement of the XR system 510 in three-dimensional space. Specifically, the 6DoF data encompasses three translational movements along the x, y, and z axes (forward/back, up/down, left/right) and three rotational movements (pitch, yaw, roll) included in pose data 550. In the context of XR, 6DoF data is allows for the tracking of both position and orientation of an object or user in 3D space.

In some examples, the one or more pose sensors 548 include one or more cameras that capture images of the real-world environment. The images are included in the pose data 550. The XR system 510 uses the images and photogrammetric methodologies to determine 6DoF data of the XR system 510.

In some examples, the XR system 510 uses a combination of an IMU and one or more cameras to determine 6DoF for the XR system 510.

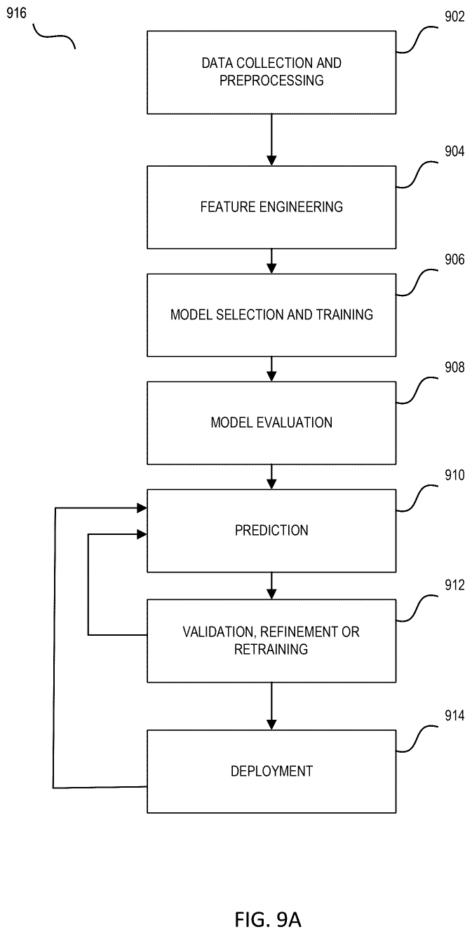

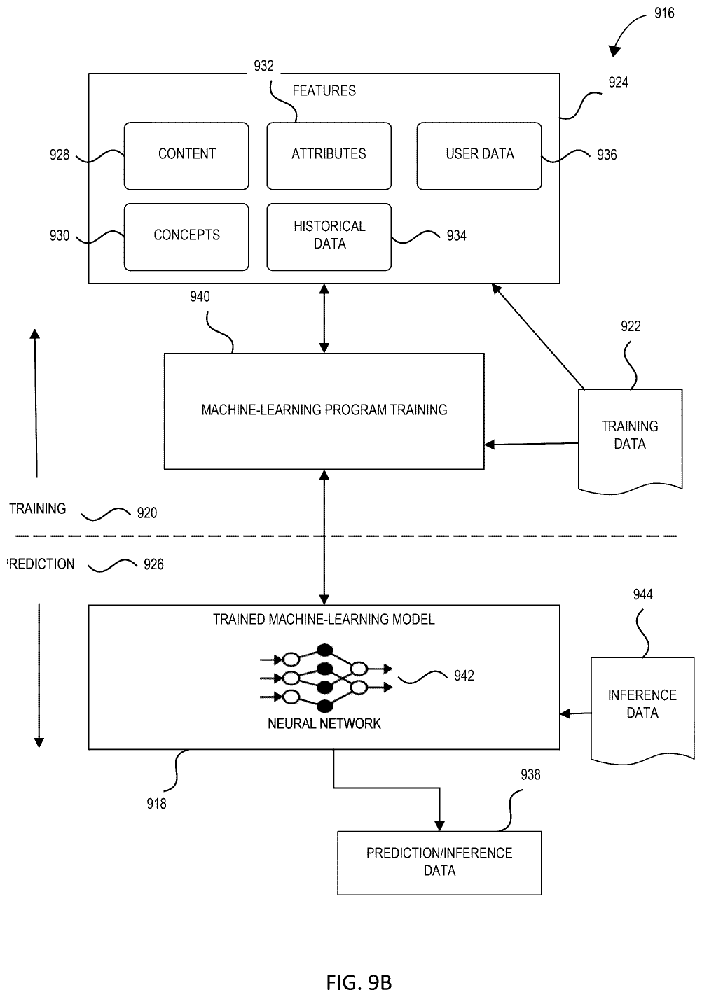

In some examples, the XR system 510 uses one or more audio sensors 590 to capture user speech of the user 508. The one or more audio sensors 590 capture the user speech and generate audio data 596 that is communicated to a speech recognition pipeline 588. The speech recognition pipeline 588 receives the audio data 596 and generates speech data 594 that is communicated to the user interface engine 506 for processing as user input. In some examples, the speech recognition pipeline 588 includes one or more speech recognition models 592 used to process the audio data 596 into speech data 594. The training of a speech recognition model 592 is more fully described in reference to FIG. 9A and FIG. 9B.

In some examples, the XR system 510 uses a tracking pipeline 516 including a Region Of Interest (ROI) detector 530, a tracker 504, and a 3D model generator 540, to generate the 3D tracking data 538 using the tracking data 522 and the pose data 550.

The ROI detector 530 uses a ROI detector model 509 to detect a region in the real world environment that includes a hand 524 of the user 508. The ROI detector model 509 is trained to recognize those portions of the real-world environment that include a user's hands as more fully described in reference to FIG. 9A and FIG. 9B. The ROI detector 530 generates ROI data 536 indicating which portions of the tracking data 522 include one or more hands of the user 508 and communicates the ROI data 536 to the tracker 504.

The tracker 504 uses a tracking model 544 to generate 2D tracking data 542. The tracker 504 uses the tracking model 544 to recognize landmark features on portions of the one or both hands 524 of the user 508 captured in the tracking data 522 and within the ROI identified by the ROI detector 530. The tracker 504 extracts landmarks of the one or both hands 524 of the user 508 from the tracking data 522 using computer vision methodologies including, but not limited to, Harris corner detection, Shi-Tomasi corner detection, Scale-Invariant Feature Transform (SIFT), Speeded-Up Robust Features (SURF), Features from Accelerated Segment Test (FAST), Oriented FAST and Rotated BRIEF (ORB), and the like. The tracking model 544 operates on the landmarks to generate the 2D tracking data 542 that includes a sequence of skeletal models of one or more hands of the user 508. The tracking model 544 is trained to generate the 2D tracking data 542 as more fully described in reference to FIG. 9A and FIG. 9B. The tracker communicates the 2D tracking data 542 to the 3D model generator 540.

The 3D model generator 540 receives the 2D tracking data 542 and generates 3D tracking data 538 using the 2D tracking data 542, the pose data 550, and a 3D coordinate generator model 546. For example, the 3D model generator 540 determines a reference position in the real-world environment for the XR system 510. The 3D model generator 540 uses a 3D coordinate generator model 546 that operates on the 2D tracking data 542 to generate the 3D tracking data 538. The 3D coordinate generator model 546 is trained to generate the 3D tracking data 538 as more fully described in reference to FIG. 9A and FIG. 9B.

In some examples, the tracker 504 generates the 3D tracking data 538 using photogrammetry methodologies to create 3D models of the hands of the user 508 from the 2D tracking data 542 by capturing overlapping pictures of the hands of the user 508 from different angles. In some examples, the 2D tracking data 542 includes multiple images taken from different angles, which are then processed to generate the 3D models that are included in the 3D tracking data 538. In some examples, the XR system 510 uses the pose data 550 captured by one or more pose sensors 548 to determine an angle or position of the XR system 510 as an image is captured of the hands of the user 508.

The XR system 510 uses a hand touch detection pipeline 554 including an image processor 556 and a hand touch detector 558 to generate hand touch data 564 using the tracking data 522.

In some examples, the image processor 556 extracts features from the tracking data 522 using computer vision methodologies including, but not limited to, Harris corner detection, Shi-Tomasi corner detection, Scale-Invariant Feature Transform (SIFT), Speeded-Up Robust Features (SURF), Features from Accelerated Segment Test (FAST), Oriented FAST and Rotated BRIEF (ORB), and the like. The image processor 556 operates on the features to generate the cropped image data 566. The image processor 556 is trained to generate the cropped image data 566 as more fully described in reference to FIG. 9A and FIG. 9B.

In some examples, images in the tracking data 522 are processed by an image processor 556 to enhance the images for better clarity and contrast, making it easier for the XR system 510 to extract features from the tracking data 522. In some examples, the image processor 556 uses image enhancement methodologies such as, but not limited to: histogram equalization, which adjusts the contrast of an image by redistributing the intensity values;

Gaussian smoothing, which reduces noise and detail by averaging pixel values with a Gaussian kernel; unsharp mask filtering, which enhances edges by subtracting a blurred version of the image from the original; Wiener filtering, which removes noise and deblurs images by accounting for both the degradation function and the statistical properties of noise; Contrast-Limited Adaptive Histogram Equalization (CLAHE), which improves local contrast and enhances the definition of edges in an image; median filtering, which reduces noise by replacing each pixel's value with the median value of the intensities in its neighborhood; point operations, which apply the same transformation to each pixel based on its original value, such as intensity transformations; spatial filtering, which involves convolution of the image with a kernel to achieve effects like blurring or sharpening; and the like.

In some examples, the image processor 556 filters the images to remove background noise and enhance the visibility of a portion of a hand 524 and a digit used by the user 508 to make the hand touch. This processing helps the XR system 510 to accurately detect and interpret the specific interactions intended by the user 508. This capability is useful in complex visual environments where background noise could otherwise interfere with the ability of the XR system 510 to correctly detect a hand touch.

The image processor 556 detects portions of images of the tracking data 522 that include image data of the hands 524 and 586 of the user 508 and crops the images to generate cropped image data 566 including the image data of the hands 524 and 586. The image processor 556 generates the cropped image data 566 and communicates the cropped image data 566 to the hand touch detector 558.

In some examples, the image processor 556 uses a cropping model 562 to crop the images of the tracking data 522 that include image data of the hands 524 and hand 586. Training of the cropping model 562 more fully described in reference to FIG. 9A and FIG. 9B.

In some examples, the image processor 556 uses a hand tracking process to isolate a palmar surface or a hand dorsal surface in images of the hands 524 and 586 of the user 508. This process is useful for focusing the analysis on the most relevant part of a palmar surface or a hand dorsal surface for interaction, which enhances the ability of the XR system 510 to accurately detect and interpret user inputs. By isolating the palmar surface or hand dorsal surface, the XR system 510 can more effectively process and respond to gestures and touches, improving the overall user experience in XR applications. This targeted processing helps in reducing noise and distractions from other parts of the hand or background, improving the precision and reliability of the hand touch detection.

In some examples, the image processor 556 uses the hand tracking process to crop an image to isolate an area around a tip of a digit being used by the user 508 to make a hand touch.

In some examples, the image processor 556 adjusts the cropping of the cropped images to enhance features indicative of the hand touch. This adjustment is useful for improving the accuracy of hand touch detection by focusing on specific areas of the image where hand touch interactions are most likely to occur. By enhancing these features, the XR system 510 can more effectively interpret user inputs, leading to a more responsive and intuitive user experience within the XR environment. This capability is particularly useful for applications requiring precise control and interaction, such as virtual reality gaming or complex navigational tasks in augmented reality settings.

As mentioned before, a hybrid approach to a viewfinder may be utilized in which two different mechanisms are used to determine how a user selects to snap an image of a real-world object in an XR view. The first mechanism is called a hand-tracked viewfinder. Here, a viewfinder is displayed around the user's dominant hand in the XR view. The user can then move the hand so that the viewfinder is over the object or objects of interest, and then the user makes a pinching motion with a dominant hand within the XR view on an object or group of objects the user in interested in snapping. The location where the user's finger touches the user's thumb may indicate the snap location (e.g., take a snap of the object behind the location where the finger touches the thumb). The object or objects selected are then “snapped”, with the viewfinder transitioning to a similar box indicating that a capture has been taken, and this image can then be passed to a processing system as context for a query. This visual indicator can be a valuable tool in that it allows, for example, the user to cancel the snap if the system is attempting to snap a different object or objects than the user intended.

The second mechanism is called a head-tracked viewfinder. Here, a viewfinder window automatically forms around an object in or near the center of the view, allowing the user to simply “look” at an object for a snap to occur. The actual snap of the image may be triggered, for example, by the user ceasing to speak to the AI chatbot. A delay may be introduced between the time the image is “snapped” (prompted by the user ceasing to speak to the AI chatbot) and when the image is used as context for a query or otherwise processed. This delay allows the user time to cancel the selection of what real-world object is being snapped. In some instances this delay may be visually depicted, such as by a countdown or a circular bar that slowly fills in to complete a circle, with the completion of the circle marking the end of the delay period.

Both of these viewfinders may be opt-in, and specifically may be activated through, for example, selecting a camera button or a voice request asking a question about or related to an object.

As mentioned earlier, a hybrid approach is also provided, where the hand-tracked viewfinder is utilized when the dominant hand of the user is within the view of the XR experience (e.g., visible to the user wearing the head-wearable device), while the head-tracked viewfinder is utilized when the dominant hand of the user is not within the view of the XR experience (e.g., not visible to the user wearing the head-wearable device)

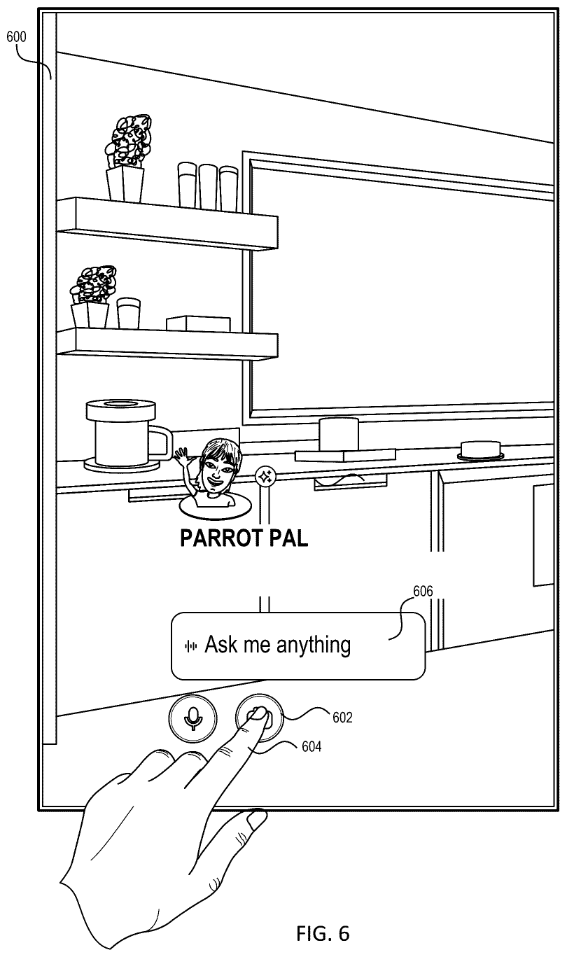

FIG. 6 is a diagram illustrating an XR view 600, in accordance with an example. Here, a user may select a camera button 602 by, for example, pointing to the camera button 602 with a finger 604 of the user's hand and possibly making a “pressing” or other movement with the finger 604 to indicate a selection of the camera button 602. This indicates an intent to snap an image of a real-world object in the XR view 600. It should be noted that this is only one possible mechanism to indicate such an intent. Other mechanisms are possible as well, such as the user speaking verbally to an AI chatbot 606 with a request to snap an image in the XR view 600.

Regardless of the mechanism used to indicate the intent to snap an image, once the intent is understood by the system, a hybrid viewfinder mode may be entered. The hybrid viewfinder mode alters the type of viewfinder user based on whether the user's dominant hand is visible in the XR view 600 or not. If the user's dominant hand is not visible in the XR view, then a head-only viewfinder mode is entered.

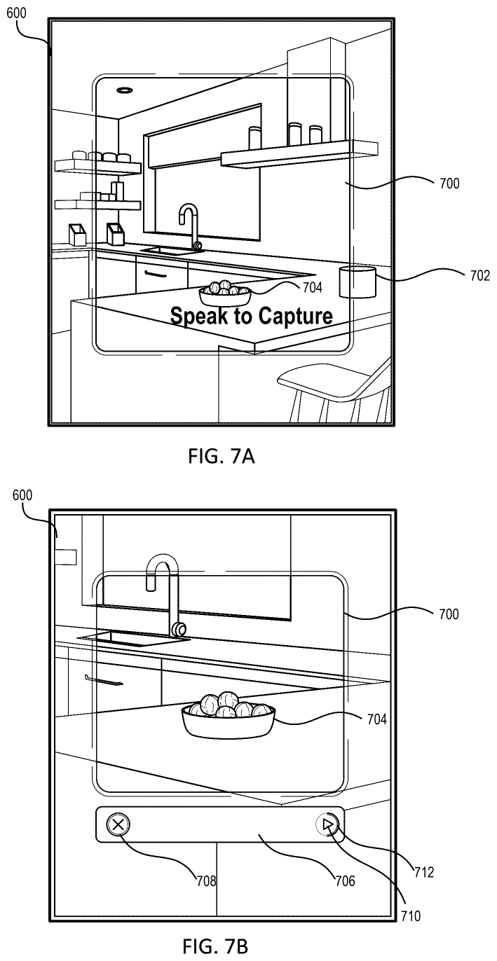

FIGS. 7A and 7B are diagrams illustrating an XR view 600 in a head-only viewfinder mode, in accordance with an example. As can be seen in FIG. 7A, a viewfinder box 700 appears in the display. The user is able to move their head around to alter the view in the XR view 600. This also causes what real-world object or object are or are not visible inside the viewfinder box 700. As such, the user is able to aim the viewfinder using head and/or body movements until the viewfinder box 700 surrounds the real-world object or objects that the user wishes to snap an image of. Thus, for example, in FIG. 7A if the user had wished to snap an image of the pot 702, then the user could turn their head to the right until the pot 702 appeared within the viewfinder box 700.

Here, however, the user is interested in snapping an image of the bowl 704. Once the user has aimed so that the bowl 704 appears within the viewfinder box 700, the user may use a voice command to snap the image. Once this act has been performed, the view in FIG. 7B is revealed. Here, a snap capture bar 706 is rendered, which includes a cancel button 708 and a proceed button 710. Also depicted is a visual indicator 712 of the amount of time until the snap is processed for use as context for a search query. The user can, for example, select the proceed button 710 to have the snap processed immediately, or the user can simply wait and after the delay has completed, the snap will be processed automatically. The visual indicator 712 here is portion of a circle surrounding the proceed button 710. The concept is that this circle will initially not be present but will slowly form and work its way around the proceed button 710 in synchronization with the delay. Thus, for example, here the visual indicator 712 appears to be a half-circle, indicating that about half of the delay has elapsed. If the visual indicator 712 was ¾ of a circle, then this would indicate that ¾^{th} of the delay had elapsed.

The result is that the snap may be captured hands-free, as the user simply needs to point the viewfinder box 700 at the bowl 704, speak to capture it, and then wait until the delay has elapsed and an image of the bowl 704 will be processed and used as context for a search. The delay, however, allows the user to cancel the processing of the image if, for example, the user did not intend to capture the image of the bowl 704 but rather was trying to capture a different object.

This head-only mode continues until the user's dominant hand appears in the XR view 600. At that point, a hand-only viewfinder mode is entered.

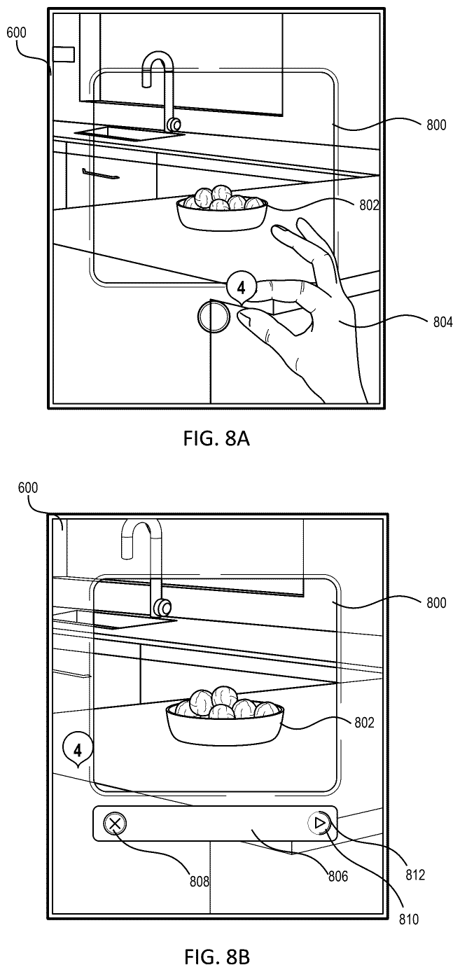

FIGS. 8A and 8B are diagrams illustrating an XR view 600 in a hand-only viewfinder mode, in accordance with an example. Once again a viewfinder box 800 is depicted in the view. Here, however, rather than the user aiming the viewfinder box 800 towards the bowl 802 using head/body movements that move the XR headset and then simply using voice commands, the user's dominant hand 804 makes a pinching motion near the viewfinder box 800, causing the snap to be taken.

Once this act has been performed, the view in FIG. 8B is revealed. Similar to FIG. 7B, here, a snap capture bar 806 is rendered, which includes a cancel button 808 and a proceed button 810. Also depicted is a visual indicator 812 of the amount of time until the snap is processed for use as context for a search query. The user can, for example, select the proceed button 810 to have the snap processed immediately, or the user can simply wait and after the delay has completed, the snap will be processed automatically. The visual indicator 812, like in FIG. 7B, here is portion of a circle surrounding the proceed button 810.

Referring back to FIG. 5, the hand touch model 560 is trained to generate the hand touch data 564 as more fully described in reference to FIG. 9A, and FIG. 9B.

In some examples, the hand touch model 560 is retrained using a training data collected by the XR system as the XR system prompts the user 508 to perform specific operations such as, but not limited to, holding a digit over a palm of one their hands, palm touching specific portions of their palm, and the like. This retraining process is useful for personalizing the model to the specific characteristics and preferences of the user 508. By incorporating user-specific data, the XR system 510 can enhance hand touch accuracy and responsiveness to a user's unique way of interacting with the XR system 510. This capability is particularly beneficial in applications where user comfort and customization improve the overall experience, such as in personalized virtual assistance or adaptive gaming environments.

In some examples, the hand touch detection sensitivity of the hand touch detection pipeline 554 is calibrated using a set of individual hand characteristics of the user 508. This calibration process is useful for tailoring the system's sensitivity to the unique physical attributes of the user's hands, such as size, shape, and touch pressure tendencies.

In some examples, detecting a hand touch of a palm by a digit of a hand includes interpolating between different hand touch pressure levels detected in the cropped images. For example, the hand touch detector 558 uses the hand touch model 560 to detect variations in visual cues such as, but not limited to, shadowing, indentation, skin deformation, and the like, which are captured in the cropped images. By interpolating these subtle differences, the XR system 510 can determine not just the presence of a touch, but also the varying degrees of pressure applied. In some examples, the hand touch detector 558 generates data of a hand touch that includes a continuous parameter that has a value representing states of a hand touch from a hover state to a hard press state. As an example, the continuous value can be a real number having a range from 0.0 to 2.0 where 0.0 represents a hover of a digit over a palm, 1.0 represents a light pressure hand touch, and 2.0 represents a heavy pressure hand touch, and a value between 0.0 and 1.0 represents a distance between the digit and the palm without a hand touch corresponding to the user 508 holding their digit just above their palmar surface in a hover position.

In some examples, the one or more tracking sensors 520 include one or more visible light cameras such as, but not limited to, RGB cameras, that capture the images of the hands 524 of user 508. The cropped images are processed by the image processor 556 to emphasize depth cues visible in the hands 524 of the user in the RGB spectrum. This processing is useful for enhancing the visual information used for accurately interpreting hand movements and interactions within the XR environment. By emphasizing depth cues, the XR system 510 can more effectively discern the spatial relationships and gestures of the user's hands, leading to more precise and responsive interactions in virtual and augmented reality applications.

In some examples, the XR system 510 is operably connected to a mobile device 552. The user 508 can use the mobile device 552 to configure the XR system 510. In some examples, the mobile device 552 functions as an alternative input modality.

In some examples, an XR system performs the functions of the tracking pipeline 516, the hand touch detection pipeline 554, the user interface engine 506, and the optical engine 517 utilizing various APIs and system libraries.

### Machine-Learning Pipeline

FIG. 9B is a flowchart depicting a machine-learning pipeline 916, according to some examples. The machine-learning pipeline 916 can be used to generate a trained machine-learning model 918 such as, but not limited to, speech recognition model 592 of FIG. 5, ROI detector model 509 of FIG. 5, tracking model 544 of FIGS. 5, 3D coordinate generator model 546 of FIG. FIG. 5, cropping model 562 of FIG. 5, hand touch model 560 of FIG. 5, and the like, to perform operations associated with determining user inputs into an XR system, such as XR system 510 of FIG. 5.

Machine learning can involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that can be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting can be used in various machine learning applications.

Three example types of problems in machine learning are classification problems, regression problems, and generation problems. Classification problems, also referred to as categorization problems, aim at classifying items into one of several category values (for example, is this object an apple or an orange?). Regression algorithms aim at quantifying some items (for example, by providing a value that is a real number). Generation algorithms aim at producing new examples that are similar to examples provided for training. For instance, a text generation algorithm is trained on many text documents and is configured to generate new coherent text with similar statistical properties as the training data.

Generating a trained machine-learning model 918 can include multiple phases that form part of the machine-learning pipeline 916, including for example the following phases illustrated in FIG. 9A:
Data collection and preprocessing 902: This phase can include acquiring and cleaning data to ensure that it is suitable for use in the machine learning model. This phase can also include removing duplicates, handling missing values, and converting data into a suitable format.
Feature engineering 904: This phase can include selecting and transforming the training data 922 to create features that are useful for predicting the target variable. Feature engineering can include (1) receiving features 924 (e.g., as structured or labeled data in supervised learning) and/or (2) identifying features 924 (e.g., unstructured or unlabeled data for unsupervised learning) in training data 922.
Model selection and training 906: This phase can include selecting an appropriate machine learning algorithm and training it on the preprocessed data. This phase can further involve splitting the data into training and testing sets, using cross-validation to evaluate the model, and tuning hyperparameters to improve performance.
Model evaluation 908: This phase can include evaluating the performance of a trained model (e.g., the trained machine-learning model 918) on a separate testing dataset. This phase can help determine if the model is overfitting or underfitting and determine whether the model is suitable for deployment.
Prediction 910: This phase involves using a trained model (e.g., trained machine-learning model 918) to generate predictions on new, unseen data.
Validation, refinement or retraining 912: This phase can include updating a model based on feedback generated from the prediction phase, such as new data or user feedback.
Deployment 914: This phase can include integrating the trained model (e.g., the trained machine-learning model 918) into a more extensive system or application, such as a web service, mobile app, or IoT device. This phase can involve setting up APIs, building a user interface, and ensuring that the model is scalable and can handle large volumes of data.

FIG. 9B illustrates further details of two example phases, namely a training phase 920 (e.g., part of the model selection and trainings 906) and a prediction phase 926 (part of prediction 910). Prior to the training phase 920, feature engineering 904 is used to identify features 924. This can include identifying informative, discriminating, and independent features for effectively operating the trained machine-learning model 918 in pattern recognition, classification, and regression. In some examples, the training data 922 includes labeled data, known for pre-identified features 924 and one or more outcomes. Each of the features 924 can be a variable or attribute, such as an individual measurable property of a process, article, system, or phenomenon represented by a data set (e.g., the training data 922). Features 924 can also be of different types, such as numeric features, strings, and graphs, and can include one or more of content 928, concepts 930, attributes 932, historical data 934, and/or user data 936, merely for example.

In training phase 920, the machine-learning pipeline 916 uses the training data 922 to find correlations among the features 924 that affect a predicted outcome or prediction/inference data 938.

With the training data 922 and the identified features 924, the trained machine-learning model 918 is trained during the training phase 920 during machine-learning program training 940. The machine-learning program training 940 appraises values of the features 924 as they correlate to the training data 922. The result of the training is the trained machine-learning model 918 (e.g., a trained or learned model).

Further, the training phase 920 can involve machine learning, in which the training data 922 is structured (e.g., labeled during preprocessing operations). The trained machine-learning model 918 implements a neural network 942 capable of performing, for example, classification and clustering operations. In other examples, the training phase 920 can involve deep learning, in which the training data 922 is unstructured, and the trained machine-learning model 918 implements a deep neural network 942 that can perform both feature extraction and classification/clustering operations.

In some examples, a neural network 942 can be generated during the training phase 920, and implemented within the trained machine-learning model 918. The neural network 942 includes a hierarchical (e.g., layered) organization of neurons, with each layer consisting of multiple neurons or nodes. Neurons in the input layer receive the input data, while neurons in the output layer produce the final output of the network. Between the input and output layers, there can be one or more hidden layers, each consisting of multiple neurons.

Each neuron in the neural network 942 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks can use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 942 can also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 920, a validation phase can be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model can be tested on a new dataset. The testing dataset is used to evaluate the model's performance and ensure that the model has not overfitted the training data.

In prediction phase 926, the trained machine-learning model 918 uses the features 924 for analyzing inference data 944 to generate inferences, outcomes, or predictions, as examples of a prediction/inference data 938. For example, during prediction phase 926, the trained machine-learning model 918 generates an output. Inference data 944 is provided as an input to the trained machine-learning model 918, and the trained machine-learning model 918 generates the prediction/inference data 938 as output, responsive to receipt of the inference data 944.

In some examples, the trained machine-learning model 918 can be a generative AI model. Generative AI is a term that can refer to any type of artificial intelligence that can create new content from training data 922. For example, generative AI can produce text, images, video, audio, code, or synthetic data similar to the original data but not identical. In cases where the trained machine-learning model 918 is a generative AI, inference data 944 can include text, audio, image, video, numeric, or media content prompts and the output prediction/inference data 938 can include text, images, video, audio, code, or synthetic data.

Some of the techniques that can be used in generative AI are:
Convolutional Neural Networks (CNNs): CNNs can be used for image recognition and computer vision tasks. CNNs can, for example, be designed to extract features from images by using filters or kernels that scan the input image and highlight important patterns.
Recurrent Neural Networks (RNNs): RNNs can be used for processing sequential data, such as speech, text, and time series data, for example. RNNs employ feedback loops that allow them to capture temporal dependencies and remember past inputs.
Generative adversarial networks (GANs): GANs can include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs can encode input data into a latent space (e.g., a compressed representation) and then decode it back into output data. The latent space can be manipulated to generate new variations of the output data. VAEs can use self-attention mechanisms to process input data, allowing them to handle long text sequences and capture complex dependencies.
Transformer models: Transformer models can use attention mechanisms to learn the relationships between different parts of input data (such as words or pixels) and generate output data based on these relationships. Transformer models can handle sequential data, such as text or speech, as well as non-sequential data, such as images or code.

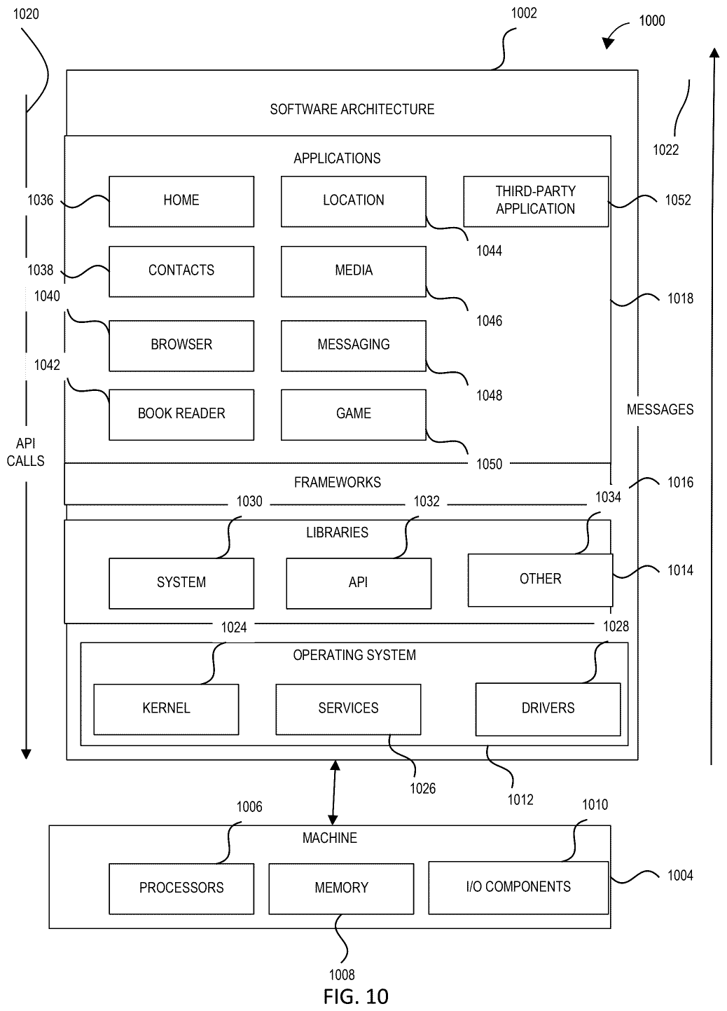

FIG. 10 is a block diagram 1000 illustrating a software architecture 1002, which can be installed on any one or more of the devices described herein. The software architecture 1002 is supported by hardware such as a machine 1004 that includes processors 1006, memory 1008, and I/O components 1010. In this example, the software architecture 1002 can be conceptualized as a stack of layers, where each layer provides a particular functionality. The software architecture 1002 includes layers such as an operating system 1012, libraries 1014, frameworks 1016, and applications 1018. Operationally, the applications 1018 invoke API calls 1020 through the software stack and receive messages 1022 in response to the API calls 1020.

The operating system 1012 manages hardware resources and provides common services. The operating system 1012 includes, for example, a kernel 1024, services 1026, and drivers 1028. The kernel 1024 acts as an abstraction layer between the hardware and the other software layers. For example, the kernel 1024 provides memory management, processor management (e.g., scheduling), component management, networking, and security settings, among other functionalities. The services 1026 can provide other common services for the other software layers. The drivers 1028 are responsible for controlling or interfacing with the underlying hardware. For instance, the drivers 1028 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1014 provide a common low-level infrastructure used by the applications 1018. The libraries 1014 can include system libraries 1030 (e.g., C standard library) that provide functions such as memory allocation functions, string manipulation functions, mathematical functions, and the like. In addition, the libraries 1014 can include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1014 can also include a wide variety of other libraries 1034 to provide many other APIs to the applications 1018.

The frameworks 1016 provide a common high-level infrastructure that is used by the applications 1018. For example, the frameworks 1016 provide various graphical user interface (GUI) functions, high-level resource management, and high-level location services. The frameworks 1016 can provide a broad spectrum of other APIs that can be used by the applications 1018, some of which can be specific to a particular operating system or platform.

In an example, the applications 1018 can include a home application 1036, a contacts application 1038, a browser application 1040, a book reader application 1042, a location application 1044, a media application 1046, a messaging application 1048, a game application 1050, and a broad assortment of other applications such as a third-party application 1052. The applications 1018 are programs that execute functions defined in the programs. Various programming languages can be employed to create one or more of the applications 1018, structured in a variety of manners, such as object-oriented programming languages (e.g., Objective-C, Java, or C++) or procedural programming languages (e.g., C or assembly language). In a specific example, the third-party application 1052 (e.g., an application developed using the ANDROID™ or IOS™ software development kit (SDK) by an entity other than the vendor of a platform) can be mobile software running on a mobile operating system such as IOS™, ANDROID™, WINDOWS® Phone, or another mobile operating system. In this example, the third-party application 1052 can invoke the API calls 1020 provided by the operating system 1012 to facilitate functionalities described herein.

Described implementations of the subject matter can include one or more features, alone or in combination as illustrated below by way of example:

Example 1 is a machine-implemented method, comprising: generating a user interface for an eXtended Reality (XR) system; displaying, within the user interface, real-world objects in front of a camera attached to the XR system; displaying, in the user interface, a viewfinder comprising a box where an interior of the box is at least partially transparent so that a user can see real-world objects behind the box; determining that a palm of a dominant hand of the user is not visible in the user interface; in response to the determining that the palm of the dominant hand of the user is not visible in the user interface, entering a head viewfinder mode where a first image is snapped based on voice data from the user via a microphone on the XR system; determining that palm of a dominant hand of the user is visible in the user interface; and in response to the determining that the palm of the dominant hand of the user is visible in the user interface, entering a hand viewfinder mode where a second image is snapped based on movement of one or more fingers of the dominant hand.

In Example 2, the subject matter of Example 1 includes, wherein the operations further comprise, in the head viewfinder mode: receiving the voice data; upon detecting an end of the voice data, snapping the first image of a first real-world object contained in the viewfinder; and displaying an indication of the first image in the user interface; and processing the first image as context to a first query based on the voice data;

2. The machine-implemented method of Example 1, wherein the operations further comprise, in the hand viewfinder mode: detecting a pinching motion on the dominant hand of the user, the pinching motion comprising touching a tip of a finder of the dominant hand to a tip of a thumb of the dominant hand; in response to the detection of the pinching motion, snapping the second image of a second real-world object contained in the viewfinder; and displaying an indication of the second image in the user interface; and processing the second image as context to a second query.

In Example 4, the subject matter of Examples 1-3 includes, wherein the displaying of the viewfinder is performed in response to a user action indicating an intent to capture an image of a real-world object.

In Example 5, the subject matter of Examples 1-4 includes, wherein the displaying the indication includes displaying a cancel button that, if selected by the user, cancels the processing of the first image.

In Example 6, the subject matter of Example 3 includes, in the head viewfinder mode, causing a delay between displaying the indication of the first image and the processing the first image.

In Example 7, the subject matter of Example 6 includes, displaying a visual indication of a remainder of time in the delay in the user interface.

Example 8 is an XR headset, comprising: a camera; a light projector configured to provide visible light that represents a user interface of an XR system overlaid over an image of real-world objects in front of the camera; a controller configured to: generate a user interface for an eXtended Reality (XR) system; display, within the user interface, real-world objects in front of a camera attached to the XR system; display, in the user interface, a viewfinder comprising a box where an interior of the box is at least partially transparent so that a user can see real-world objects behind the box; determine that a palm of a dominant hand of the user is not visible in the user interface; in response to the determining that the palm of the dominant hand of the user is not visible in the user interface, enter a head viewfinder mode where a first image is snapped based on voice data from the user via a microphone on the XR system; determine that palm of a dominant hand of the user is visible in the user interface; and in response to the determining that the palm of the dominant hand of the user is visible in the user interface, enter a hand viewfinder mode where a second image is snapped based on movement of one or more fingers of the dominant hand.

In Example 9, the subject matter of Example 8 includes, wherein the displaying of the viewfinder is performed in response to a user action indicating an intent to capture an image of a real-world object.

In Example 10, the subject matter of Examples 8-9 includes, wherein the displaying the indication includes displaying a cancel button that, if selected by the user, cancels the processing of the first image.

In Example 11, the subject matter of Examples 8-10 includes, wherein the controller is further configured to display search results from the first query in the user interface.

In Example 12, the subject matter of Examples 8-11 includes, wherein the XR system is a head-wearable apparatus.

In Example 13, the subject matter of Examples 10-12 includes, wherein the controller is further configured to in the head viewfinder mode, cause a delay between displaying the indication of the first image and the processing the first image.

In Example 14, the subject matter of Example 13 includes, wherein the controller is further configured to display a visual indication of a remainder of time in the delay in the user interface.

Example 15 is a non-transitory machine-readable medium storing instructions which, when executed by one or more processors, cause the one or more processors to perform operations comprising: generating a user interface for an eXtended Reality (XR) system; displaying, within the user interface, real-world objects in front of a camera attached to the XR system; displaying, in the user interface, a viewfinder comprising a box where an interior of the box is at least partially transparent so that a user can see real-world objects behind the box; determining that a palm of a dominant hand of the user is not visible in the user interface; in response to the determining that the palm of the dominant hand of the user is not visible in the user interface, entering a head viewfinder mode where a first image is snapped based on voice data from the user via a microphone on the XR system; determining that palm of a dominant hand of the user is visible in the user interface; and in response to the determining that the palm of the dominant hand of the user is visible in the user interface, entering a hand viewfinder mode where a second image is snapped based on movement of one or more fingers of the dominant hand.

In Example 16, the subject matter of Example 15 includes, wherein the displaying of the viewfinder is performed in response to a user action indicating an intent to capture an image of a real-world object.

In Example 17, the subject matter of Examples 15-16 includes, wherein the displaying the indication includes displaying a cancel button that, if selected by the user, cancels the processing of the first image.

In Example 18, the subject matter of Examples 15-17 includes, wherein the operations further comprise displaying search results from the first query in the user interface.

In Example 19, the subject matter of Examples 15-18 includes, wherein the XR system is a head-wearable apparatus.

In Example 20, the subject matter of Examples 17-18 includes, wherein the operations further comprise, in the head viewfinder mode, causing a delay between displaying the indication of the first image and the processing the first image.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The various features, operations, or processes described herein can be used independently of one another, or can be combined in various ways. All possible combinations and sub-combinations are intended to fall within the scope of this disclosure. In addition, certain method or process blocks can be omitted in some implementations.

Although some examples, e.g., those depicted in the drawings, include a particular sequence of operations, the sequence can be altered without departing from the scope of the present disclosure. For example, some of the operations depicted can be performed in parallel or in a different sequence that does not materially affect the functions as described in the examples. In other examples, different components of an example device or system that implements an example method can perform functions at substantially the same time or in a specific sequence.

Changes and modifications can be made to the disclosed examples without departing from the scope of the present disclosure. These and other changes or modifications are intended to be included within the scope of the present disclosure, as expressed in the appended claims.

### Term Examples

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number can also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

“Carrier signal” can include, for example, any intangible medium that can store, encoding, or carrying instructions for execution by the machine and includes digital or analog communications signals or other intangible media to facilitate communication of such instructions. Instructions can be transmitted or received over a network using a transmission medium via a network interface device.

“Client device” can include, for example, any machine that interfaces to a network to obtain resources from one or more server systems or other client devices. A client device can be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user can use to access a network.

“Component” can include, for example, a device, physical entity, or logic having boundaries defined by function or subroutine calls, branch points, APIs, or other technologies that provide for the partitioning or modularization of particular processing or control functions. Components can be combined via their interfaces with other components to carry out a machine process. A component can be a packaged functional hardware unit designed for use with other components and a part of a program that usually performs a particular function of related functions. Components can constitute either software components (e.g., code embodied on a machine-readable medium) or hardware components. A “hardware component” is a tangible unit capable of performing certain operations and can be configured or arranged in a certain physical manner. In various examples, one or more computer systems (e.g., a standalone computer system, a client computer system, or a server computer system) or one or more hardware components of a computer system (e.g., a processor or a group of processors) can be configured by software (e.g., an application or application portion) as a hardware component that operates to perform certain operations as described herein. A hardware component can also be implemented mechanically, electronically, or any suitable combination thereof. For example, a hardware component can include dedicated circuitry or logic that is permanently configured to perform certain operations. A hardware component can be a special-purpose processor, such as a field-programmable gate array (FPGA) or an application-specific integrated circuit (ASIC). A hardware component can also include programmable logic or circuitry that is temporarily configured by software to perform certain operations. For example, a hardware component can include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), can be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor can be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components can be regarded as being communicatively coupled. Where multiple hardware components exist contemporaneously, communications can be achieved through signal transmission (e.g., over appropriate circuits and buses) between or among two or more of the hardware components. In examples in which multiple hardware components are configured or instantiated at different times, communications between such hardware components can be achieved, for example, through the storage and retrieval of information in memory structures to which the multiple hardware components have access. For example, one hardware component can perform an operation and store the output of that operation in a memory device to which it is communicatively coupled. A further hardware component can then, at a later time, access the memory device to retrieve and process the stored output. Hardware components can also initiate communications with input or output devices, and can operate on a resource (e.g., a collection of information). The various operations of example methods described herein can be performed, at least partially, by one or more processors that are temporarily configured (e.g., by software) or permanently configured to perform the relevant operations. Whether temporarily or permanently configured, such processors can constitute processor-implemented components that operate to perform one or more operations or functions described herein. As used herein, “processor-implemented component” can refer to a hardware component implemented using one or more processors. Similarly, the methods described herein can be at least partially processor-implemented, with a particular processor or processors being an example of hardware. For example, at least some of the operations of a method can be performed by one or more processors or processor-implemented components. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API). The performance of certain of the operations can be distributed among the processors, not only residing within a single machine, but deployed across a number of machines. In some examples, the processors or processor-implemented components can be located in a single geographic location (e.g., within a home environment, an office environment, or a server farm). In other examples, the processors or processor-implemented components can be distributed across a number of geographic locations.

“Computer-readable medium” can include, for example, both machine-storage media and signal media. Thus, the terms include both storage devices/media and carrier waves/modulated data signals. The terms “machine-readable medium,” “computer-readable medium” and “device-readable medium” mean the same thing and can be used interchangeably in this disclosure.

“Machine-storage medium” can include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine-storage medium can also refer to cloud storage services, Network Attached Storage (NAS), Storage Area Networks (SAN), and object storage devices. The terms “machine-storage medium,” “device-storage medium,” “computer-storage medium” mean the same thing and can be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” can include, for example, one or more portions of a network that can be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network can include a wireless or cellular network, and the coupling can be a Code Division Multiple Access (CDMA) connection, a Global System for Mobile communications (GSM) connection, or other types of cellular or wireless coupling. In this example, the coupling can implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable medium” can include, for example, a tangible medium that is capable of storing, encoding, or carrying the instructions for execution by a machine.

“Processor” can include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” can include multi-core processors that can comprise two or more independent processors (sometimes referred to as “cores”) that can execute instructions contemporaneously. These cores can be homogeneous (e.g., all cores are identical, as in multicore CPUs) or heterogeneous (e.g., cores are not identical, as in many modern GPUs and some CPUs). In addition, the term “processor” can also encompass systems with a distributed architecture, where multiple processors are interconnected to perform tasks in a coordinated manner. This includes cluster computing, grid computing, and cloud computing infrastructures. Furthermore, the processor can be embedded in a device to control specific functions of that device, such as in an embedded system, or it can be part of a larger system, such as a server in a data center. The processor can also be virtualized in a software-defined infrastructure, where the processor's functions are emulated in software.

“Signal medium” can include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and can be used interchangeably in this disclosure.

“User device” can include, for example, a device accessed, controlled or owned by a user and with which the user interacts perform an action, engagement or interaction on the user device, including an interaction with other users or computer systems.

What is claimed is:

1. A machine-implemented method, comprising:
generating a user interface for an eXtended Reality (XR) system;
displaying, within the user interface, real-world objects in front of a camera attached to the XR system;
displaying, in the user interface, a viewfinder comprising a box where an interior of the box is at least partially transparent so that a user can see real-world objects behind the box;
determining that a palm of a dominant hand of the user is not visible in the user interface;
in response to the determining that the palm of the dominant hand of the user is not visible in the user interface, entering a head viewfinder mode where a first image is snapped based on voice data from the user via a microphone on the XR system;
determining that palm of a dominant hand of the user is visible in the user interface; and
in response to the determining that the palm of the dominant hand of the user is visible in the user interface, entering a hand viewfinder mode where a second image is snapped based on movement of one or more fingers of the dominant hand.

2. The machine-implemented method of claim 1, wherein the operations further comprise, in the head viewfinder mode:
receiving the voice data;
upon detecting an end of the voice data, snapping the first image of a first real-world object contained in the viewfinder; and
displaying an indication of the first image in the user interface; and
processing the first image as context to a first query based on the voice data.

3. The machine-implemented method of claim 1, wherein the operations further comprise, in the hand viewfinder mode:
detecting a pinching motion on the dominant hand of the user, the pinching motion comprising touching a tip of a finder of the dominant hand to a tip of a thumb of the dominant hand;
in response to the detection of the pinching motion, snapping the second image of a second real-world object contained in the viewfinder; and
displaying an indication of the second image in the user interface; and
processing the second image as context to a second query.

4. The machine-implemented method of claim 1,
wherein the displaying of the viewfinder is performed in response to a user action indicating an intent to capture an image of a real-world object.

5. The machine-implemented method of claim 1,
wherein the displaying the indication includes displaying a cancel button that, if selected by the user, cancels the processing of the first image.

6. The machine-implemented method of claim 3, further comprising, in the head viewfinder mode, causing a delay between displaying the indication of the first image and the processing the first image.

7. The machine-implemented method of claim 6, further comprising, displaying a visual indication of a remainder of time in the delay in the user interface.

8. An XR headset, comprising:
a camera;
a light projector configured to provide visible light that represents a user interface of an XR system overlaid over an image of real-world objects in front of the camera;
a controller configured to:
generate a user interface for an eXtended Reality (XR) system;
display, within the user interface, real-world objects in front of a camera attached to the XR system;
display, in the user interface, a viewfinder comprising a box where an interior of the box is at least partially transparent so that a user can see real-world objects behind the box;
determine that a palm of a dominant hand of the user is not visible in the user interface;
in response to the determining that the palm of the dominant hand of the user is not visible in the user interface, enter a head viewfinder mode where a first image is snapped based on voice data from the user via a microphone on the XR system;
determine that palm of a dominant hand of the user is visible in the user interface; and
in response to the determining that the palm of the dominant hand of the user is visible in the user interface, enter a hand viewfinder mode where a second image is snapped based on movement of one or more fingers of the dominant hand.

9. The XR headset of claim 8,
wherein the displaying of the viewfinder is performed in response to a user action indicating an intent to capture an image of a real-world object.

10. The XR headset of claim 8,
wherein the displaying the indication includes displaying a cancel button that, if selected by the user, cancels the processing of the first image.

11. The XR headset of claim 8, wherein the controller is further configured to display search results from the first query in the user interface.

12. The XR headset of claim 8, wherein the XR system is a head-wearable apparatus.

13. The XR headset of claim 10, wherein the controller is further configured to in the head viewfinder mode, cause a delay between displaying the indication of the first image and the processing the first image.

14. The XR headset of claim 13, wherein the controller is further configured to display a visual indication of a remainder of time in the delay in the user interface.

15. A non-transitory machine-readable medium storing instructions which, when executed by one or more processors, cause the one or more processors to perform operations comprising:
generating a user interface for an eXtended Reality (XR) system;
displaying, within the user interface, real-world objects in front of a camera attached to the XR system;
displaying, in the user interface, a viewfinder comprising a box where an interior of the box is at least partially transparent so that a user can see real-world objects behind the box;
determining that a palm of a dominant hand of the user is not visible in the user interface;
in response to the determining that the palm of the dominant hand of the user is not visible in the user interface, entering a head viewfinder mode where a first image is snapped based on voice data from the user via a microphone on the XR system;
determining that palm of a dominant hand of the user is visible in the user interface; and
in response to the determining that the palm of the dominant hand of the user is visible in the user interface, entering a hand viewfinder mode where a second image is snapped based on movement of one or more fingers of the dominant hand.

16. The non-transitory machine-readable medium of claim 15,
wherein the displaying of the viewfinder is performed in response to a user action indicating an intent to capture an image of a real-world object.

17. The non-transitory machine-readable medium of claim 15,
wherein the displaying the indication includes displaying a cancel button that, if selected by the user, cancels the processing of the first image.

18. The non-transitory machine-readable medium of claim 15, wherein the operations further comprise displaying search results from the first query in the user interface.

19. The non-transitory machine-readable medium of claim 15, wherein the XR system is a head-wearable apparatus.

20. The non-transitory machine-readable medium of claim 17, wherein the operations further comprise, in the head viewfinder mode, causing a delay between displaying the indication of the first image and the processing the first image.
